(19) United States
(12) Patent Application Publication
(10) Pub. No.: US 2023/0099434 A1
(43) Pub. Date: Mar. 30, 2023

(54) SYSTEM AND METHOD FOR ASSEMBLING VEHICLE COMPONENTS

(71) Applicant: GM GLOBAL TECHNOLOGY OPERATIONS LLC, Detroit, MI (US)

(72) Inventors: Miguel Arturo Saez, Clarkston, MI (US); John Patrick Spicer, Plymouth, MI (US); Eric Siemen, Burtchville, MI (US); Kenneth J. Gosinski, Macomb, MI (US); Mitchell L. Washer, Leonard, MI (US)

(73) Assignee: GM GLOBAL TECHNOLOGY OPERATIONS LLC, Detroit, MI (US)

(21) Appl. No.: 17/448,984

(22) Filed: Sep. 27, 2021

(51) Int. Cl. B62D 65/02; B23P 19/04

(52) U.S. Cl. CPC B62D 65/026; B23P 19/04; B62D 65/028

(57) ABSTRACT

Methods and systems for assembling components such as for manufacturing vehicles are provided. An exemplary method includes grasping components with assembly robots and determining, with an optic robot, an identity, location, and orientation of each component. Further, the method includes determining a location adjustment and/or an orientation adjustment needed to align the components for joining based on the location and orientation of each component. The method also includes directing a respective assembly robot to move a respective component based on the location adjustment and/or the orientation adjustment to align the components for joining. The method further includes fastening, with a fastening robot, the components to each other to form a joined component.

### INTRODUCTION

The technical field generally relates to assembly systems and methods within a manufacturing plant, and more particularly to vehicle assembly systems and methods that utilize an optic robot dedicated to precisely identify the locations, orientations, and identities of components held by other robots for joining together.

A typical automotive manufacturing plant may include moving, partially assembled manufactured items through many assembly stations along a predetermined path. Assembly operations at each station are performed for a predetermined cycle time, as operation of the entire system is interconnected. Typically, a robot at an assembly station grasps a vehicle component from an expected location and performs a programmed movement to move the vehicle component to a planned location to be joined to another component. However, precision of movement of the component by the robot may be limited by robot intrinsic error; expansion and contraction of robot structures due to temperature; and variability of the component itself.

Accordingly, it is desirable to provide systems and methods for assembling components that achieve high precision with minimal complexity. In addition, it is desirable to provide systems and methods for assembling components that utilize an optic robot that is dedicated to precisely identify the locations, orientations, and identities of components throughout the assembly process at an assembly station. Furthermore, other desirable features and characteristics of embodiments will become apparent from the subsequent detailed description and the appended claims, taken in conjunction with the accompanying drawings and the foregoing technical field and background.

### SUMMARY

Systems and methods for assembling components, and methods for manufacturing vehicles are provided. In an exemplary embodiment, a method for assembling components includes grasping, with a first assembly robot, a first component from an initial position for assembly and grasping, with a second assembly robot, a second component from an initial position for assembly. The method further includes determining, with an optic robot, an identity of the first component, a location of the first component, and an orientation of the first component and determining, with the optic robot, an identity of the second component, a location of the second component, and an orientation of the second component. The method also includes determining a location adjustment and/or an orientation adjustment needed to align the first component and the second component for joining, based on the location and orientation of each component. Further, the method includes directing a respective assembly robot to move a respective component based on the location adjustment and/or the orientation adjustment to align the first component and the second component for joining and fastening, with a fastening robot, the first component to the second component to form a joined component.

In certain embodiments, the optic robot is a three-dimensional vison-based position sensor selected from the group consisting of a laser radar device, a three-dimensional stereo vision device, a white-light projection sensor device, and a laser triangulation-based sensor device and mounted on a movable robot arm. Further, in such embodiments, each assembly robot is a movable robot arm. Exemplary movable robot arms are mounted at a fixed position.

In certain embodiments, determining, with the optic robot, the identity of the first component, the location of the first component, and the orientation of the first component is performed by directing a pattern of laser pulses at the first component and analyzing reflected pulses.

In certain embodiments, determining, with the optic robot, the identity of the first component, the location of the first component, and the orientation of the first component is performed by identifying component features selected from component surface(s) component edge(s), and component opening(s).

In certain embodiments, fastening, with the fastening robot, the first component to the second component includes mechanically joining the first component to the second component.

In certain embodiments, fastening, with the fastening robot, the first component to the second component includes applying an adhesive to a surface of the first component and/or the second component. In such embodiments, the fastening robot holds an adhesive application device, and the method includes controlling, with the optic robot, a location and orientation of the fastening robot to ensure that the adhesive is correctly applied to the surface of the first component and/or the second component.

In certain embodiments, the method includes moving, with an unanchored vehicle system, the first component and the second component to the respective initial positions. In certain embodiments, the method includes moving, with an indexing system, a respective component to a respective initial position.

In certain embodiments, the method includes pre-qualifying each component with the optic robot by scanning each component and evaluating whether component features are accurately formed.

In certain embodiments, the method further includes releasing, from the second assembly robot, the joined component, wherein the first assembly robot continues grasping the joined component; grasping, with the second assembly robot, a third component from an initial position for assembly; determining, with the optic robot, an identity of the third component, a location of the third component, and an orientation of the third component; based on the location and orientation of the third component, determining a location adjustment and/or an orientation adjustment needed to align the third component and the joined component for joining; directing a respective assembly robot to move a respective component based on the location adjustment and/or the orientation adjustment to align the third component and the joined component for joining; and fastening, with a fastening robot, the third component to the joined component to modify the joined component.

In another exemplary embodiment, a method for manufacturing a vehicle is provided and includes providing a system for assembling components, wherein the system includes a central controller module; an optic robot in communication with the central controller module, wherein the optic robot includes a laser radar device; a first assembly robot and a second assembly robot, each in communication with the central controller module; and a fastening robot in communication with the central controller module. The method further includes grasping, with the first assembly robot, a first component and grasping, with a second assembly robot, a second component. Also, the method includes transmitting, with the optic robot, a pattern of pulses at each component and receiving reflected pulses to determine a location and orientation of each component. Further, the method includes moving the first component and/or the second component to align the first component and the second component for joining and fastening, with a fastening robot, the first component to the second component to form a joined component.

In certain embodiments of the method, the optic robot is a laser radar device mounted on a movable robot arm and the pattern of pulses is a pattern of laser pulses.

In certain embodiments, the method further includes analyzing, with the central controller module, the location and orientation of each component to determine a location adjustment and/or an orientation adjustment needed to align the first component and the second component for joining; and directing, with the central controller module, a respective assembly robot to move a respective component based on the location adjustment and/or the orientation adjustment to align the first component and the second component for joining.

In certain embodiments of the method, transmitting, with the optic robot, the pattern of pulses at each component and receiving reflected pulses to determine the location and orientation of each component is performed by identifying component features selected from component surface(s), component edge(s), and component opening(s).

In certain embodiments, the method further includes determining, with the central controller module and the optic robot, an identity of each component based on the reflected pulses.

In certain embodiments, the method further includes moving, with an unanchored vehicle system or an indexing system, the first component and the second component to respective initial positions.

In certain embodiments, the method further includes releasing, from the second assembly robot, the joined component, wherein the first assembly robot continues grasping the joined component; grasping, with the second assembly robot, a third component; transmitting, with the optic robot, a pattern of pulses at each component and receiving reflected pulses to determine a location and orientation of each component; moving the third component and/or the joined component to align the third component and the joined component for joining; and fastening, with a fastening robot, the third component to the joined component to modify the joined component.

In another exemplary embodiment, a system for assembling components is provided and includes a central controller module; an optic robot in communication with the central controller module, wherein the optic robot includes a laser radar device; two assembly robots in communication with the central controller module, wherein each assembly robot is configured to grasp and move a selected component; and a fastening robot in communication with the central controller module, wherein the fastening robot is configured to fasten two components to one another.

In exemplary embodiments of the system, each of the optic robot, the assembly robots, and the fastening robot is a robot arm anchored at a respective fixed location.

In exemplary embodiments, the system further includes a mobile vehicle or indexing table configured to move a selected component.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic illustration of a system for assembling components, in accordance with various embodiments; and

FIG. 2 is a flow chart illustration of a method for assembling components, in accordance with various embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the word “exemplary” means “serving as an example, instance, or illustration”. As used herein, “a,” “an,” or “the” means one or more unless otherwise specified. The term “or” can be conjunctive or disjunctive. Open terms such as “include,” “including,” “contain,” “containing” and the like mean “comprising.” In certain embodiments, numbers in this description indicating amounts, ratios of materials, physical properties of materials, and/or use are may be understood as being modified by the word “about”. The term “about” as used in connection with a numerical value and the claims denotes an interval of accuracy, familiar and acceptable to a person skilled in the art. In general, such interval of accuracy is ±10%. All numbers in this description indicating amounts, ratios of materials, physical properties of materials, and/or use may be understood as modified by the word “about,” except as otherwise explicitly indicated.

The figures are in simplified schematic form and are not to precise scale. Further, terms such as “upper”, “lower”, “above,” “over,” “below,” “under,” “upward,” “downward,” et cetera, are used descriptively of the figures, and do not represent limitations on the scope of the subject matter, as defined by the appended claims. Any numerical designations, such as “first” or “second” are illustrative only and are not intended to limit the scope of the subject matter in any way. It is noted that while embodiments may be described herein with respect to automotive applications, those skilled in the art will recognize their broader applicability.

Embodiments herein are related to the assembly of components, such as for the manufacture of vehicles. Exemplary components may be body panels for the body of a vehicle. In exemplary embodiments, a reconfigurable body assembly system and method sets the geometry of multiple body panels or components relative to each other.

During assembly, a first component is joined to a second component to form a joined component, i.e., a sub-assembly. A third component is then joined to the joined component or sub-assembly to form a modified, or added to, joined component or subassembly. The process is continued to join the desired number of components together.

In exemplary embodiments described herein, each component for assembly is delivered into or near an assembly station or cell by an automated guided vehicle or cart or by an indexing or rotating table with one or more degrees of freedom. Thereafter, a first assembly robot grasps, moves, and holds a first component, and a second assembly robot grasps, moves, and holds a second component. Also, a fastening robot joins together the first and second components while they are held in position by the assembly robots. The fastening robot may mechanically join the components together, such as with bolts or rivets, or may join the components with adhesive or sealant. Alternatively or additionally, a fixed, i.e., non-robot mounted, adhesive application system can be used to apply adhesive or sealant to a component or components.

Further, during an exemplary assembly process, an optic robot determines an identity of each component, a location of each component, and an orientation of each component. Such properties may be used to define a “state” of the component. In the systems and methods described herein the optic robot is dedicated to such determinations. In other words, the optic robot performs no other task, e.g., the optic robot does not grasp, hold, or move any component and does not fasten any components. The optic robot may analyze and determine the state of each component at selected times of assembly, or continuously. For example, the optic robot may analyze each component when received within an assembly station or cell, when grasped by an assembly robot, after being moved by an assembly robot, or at other desired assembly stages. In exemplary embodiments, a single optic robot dedicated to visual analysis is provided in an assembly station or cell, though it is envisioned that more than one optic robot could be provided in an assembly station or cell.

Through use of the optic robot dedicated to analyzing and determining the state of components, exemplary methods and systems described herein allow for precision alignment of components before and during joining, whether mechanical or adhesive. Exemplary embodiments use laser radar to measure the position of multiple body components relative to each other and adjust the assembly robot position based on the offset between measured and the required or best fit positions. Additionally or alternatively, in exemplary embodiments, an automated guided vehicle/cart or rotating/indexing table is integrated with the assembly robot and/or central controller module to change the position and orientation of components. In certain embodiments, the optic robot may analyze sealant beads or adhesive coverage and integrity during and after application for repair of sealant beads or adhesive during the assembly process.

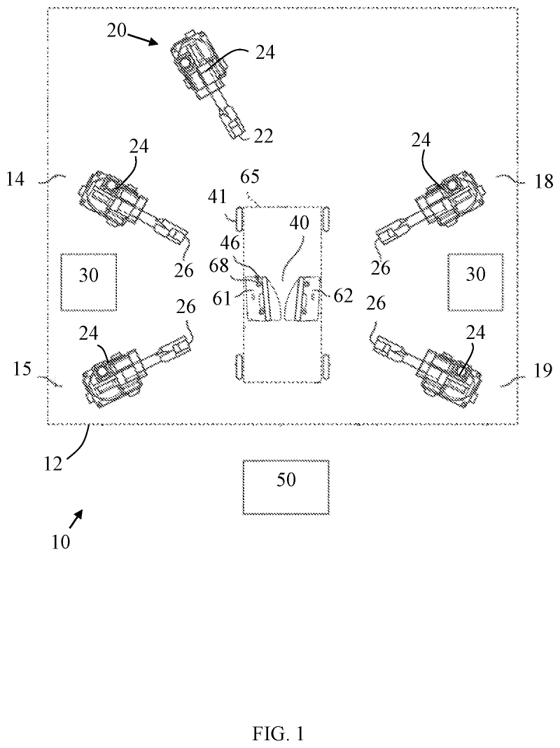

FIG. 1 is a basic diagram of an exemplary embodiment of an assembly system 10 for assembling components, such as for manufacture of a vehicle. The assembly system 10 includes a plurality of assembly stations or cells 12, of which a single cell is illustrated. During assembly, components are typically moved from assembly station to assembly station so that different assembly operations may be performed in a desired order.

In the illustrated example, the assembly station 12 is a fastening station configured to perform fastening of components. The system 10 includes two assembly robots: first assembly robot 14 and second assembly robot 15. Further, the system 10 may include a mechanical fastening robot 18 and/or an adhesive fastening robot 19.

As shown, the system 10 further includes an optic robot 20. An exemplary optic robot 20 includes a three-dimensional vison-based position sensor 22 selected from the group consisting of a laser radar device, a three-dimensional stereo vision device, a white-light projection sensor device, and a laser triangulation-based sensor device and mounted on a movable robot arm. An exemplary laser radar device 22 includes a laser transmitter and receiving, which may be included as a single transceiver unit. The laser radar device is configured to transmit and direct a laser pulse, and more particularly a sequence or pattern of laser pulses, at a target and to receive reflected pulses. An exemplary optic robot 20 includes a movable robot arm 24 that is mounted to a fixed position in the assembly station 12. The robot arm 24 is movable such that the optic robot 20 can direct laser pulses at any location within the assembly station 12. For example, the robot arm 24 may extend, retract, and rotate such that the laser radar device can be positioned at a desired location defined by X-, Y-, and Z-coordinates and can be directed at a desired angle therefrom, i.e., rotatable about the X-, Y-, and Z-axes. Similar to the optic robot 20, robots 14, 15, 18, and 19 include movable robot arms 24 that are mounted to fixed positions in the assembly station 12.

Exemplary assembly robots 14, 15 are provided with end-effectors or tools 26 that may be exchanged or replaced with other end-effectors. Specifically, an end-effector or tool 26 may be designed for specific use by an assembly robot 14 or 15 in grasping a component. After that component is processed for assembly, the assembly robot 14 or 15 may exchange the end-effector or tool 26 in use with another end-effector or tool contained within or near a tool changer 30. As shown in FIG. 1, a tool changer 30 is provided adjacent the first and second assembly robots 14 and 15 to provide for exchanging end-effectors or tools thereon during a manufacturing process.

Similarly, the fastening robots 18 and 19 may also include end-effectors 26 that may be replaced at the tool changer 30 located between the fastening robots 18 and 19.

An unmanned independent vehicle system 40 may be used to move components or subassemblies within the manufacturing plant to be assembled with other parts at the assembly stations 12 and other assembly stations. In some settings, as many as hundreds of different assembly stations could be used, each being configured to perform a different operation on the parts being moved therethrough.

Each unmanned independent vehicle system 40 may be a vehicle that has one or more wheels 41 and moves into and around the assembly station 12. The wheels 41 extend from the unmanned independent vehicle system 40 to engage a ground surface (e.g., a plant or facility floor). The wheels 41 may be any size, shape, or configuration that is convenient, and may in some examples be omnidirectional in order to provide forward and reverse motion, crabbing, and rotational movement capabilities with respect to a ground surface in order to assist in maneuvering techniques used by the unmanned independent vehicle system 40. Alternatively, one or more, or even all, of the wheels 41 may be standard wheels or casters, crawler tracks, or a conveyor system. In another alternative, an unmanned independent vehicle system 40 may be a drone having no wheels in operation when the drone is flying the parts around the plant.

Each unmanned independent vehicle system 40 may be or include one or more of the following: an automated guided vehicle (AGV), an automated guided cart (AGC), a laser guided vehicle (LGV), a vision guided vehicle (VGV), an autonomous vehicle (AV), any other wheeled vehicle, and/or a drone. In some examples, each unmanned independent vehicle system 40 includes an unmanned and self-propelled robotic vehicle that is used to transport a part along a route that can be either pre-defined or determined in real-time by the unmanned independent vehicle system 40 itself. The unmanned independent vehicle system 40 may utilize one or more controllers, optical sensors, distance sensors, global positioning system(s) (GPS), and/or laser guidance for navigation, by way of example. The navigation system can dictate a precise path for the unmanned independent vehicle system 40 to travel and provide real-time path adjustments for anything that encroaches upon the travel path of the unmanned independent vehicle system 40. In some examples, each unmanned independent vehicle system 40 may generally be autonomous in its navigation of a route or segment to a destination, in contrast to a defined or dedicated path.

Further, each unmanned independent vehicle system 40 may be or include one or more of the following: a rotating table or indexing table with one or more degrees of freedom.

As further shown in FIG. 1, the system 10 includes a central controller module 50. The central controller module may be or include an application specific integrated circuit (ASIC), an electronic circuit, a processor (shared, dedicated, or group) and memory that executes one or more software or firmware programs, a combinational logic circuit, and/or other suitable components that provide the described functionality. In exemplary embodiments, the central controller module 50 is in communication with the first and second assembly robots 14 and 15, the mechanical fastening robot 18 and/or adhesive fastening robot 19, the optic robot 20, the tool changers 30, and the unmanned vehicle system 40. Further, the exemplary central controller module 50 provides directions or instructions for each of these units. Such instructions may be based on information received by the central controller module 50 from the optic robot 20. Generally, the central control module 50 may be a facility or plant-level controller having responsibility for a facility or area within the facility, which facilitates development and assignment of material handling tasks and assembly tasks.

In FIG. 1, a first component 61 and a second component 62 to be joined together are located on an unmanned vehicle system 40 received at an assembly area 65 in the assembly station 12. The exemplary unmanned independent vehicle system 40 includes at least one locator, such as a geostationary locator, to locate each part in a precise desired position and orientation on the unmanned independent vehicle system 40. In this case, the locator is in the form of a plurality of pins 46 extending a predetermined distance above a top surface of the unmanned independent vehicle system 40. Each locator 46 arranged on the unmanned independent vehicle system 40 may engage with a part at a predetermined datum location relative to the body of the unmanned independent vehicle system 40. For example, the locator pins 46 may extend into locator holes 68 within the part such that positioning of the part may be maintained during assembly and/or manufacturing operations and when the part is being transported around the plant by the unmanned independent vehicle system 40. Each locator pin 46 may be fixedly secured to the top surface of the unmanned independent vehicle system 40 or may be movably arranged thereon. Moreover, the locator pin 46 may interface with an intermediate fixture(s) as needed for handling a part.

A robot or human material handler (not shown) may place parts upon an unmanned independent vehicle system 40. For example, a part may be placed upon a standardized fixture (not shown), on the locator pins 46, or the unmanned independent vehicle systems 40 themselves may have an end effector or other movable fixture(s) for clamping and/or carrying parts to the unmanned independent vehicle system 40.

Each unmanned independent vehicle system 40 is configured to be loaded with at least one component, such as a manufactured part upon which additional parts will be assembled at the assembly stations. In the example shown in FIG. 1, an unmanned independent vehicle system 40 is located within the first assembly station 12 and has two components 61, 62 disposed thereon, each which is a part of a vehicle door. Each of the components 61, 62 may be held in place on the unmanned independent vehicle systems 40 with the locator pins 46 and/or with one or more clamps.

In an exemplary system 10, the optic robot 20 transmits a pattern or sequence of laser pulses at each component to determine the identity of the component, such as a part number, the specific location of the component, and the specific orientation of the component. During this process, the optic robot 20 receives reflected signals from the targeted component.

Typically, the optic robot may identify component features selected from component surfaces, component edges, and component openings in order to identify the component identity, location, and orientation. Further, at this stage, the optic robot may pre-qualify or otherwise ensure that the component is properly manufactured, having component features at expected locations.

The optic robot 20 may include a device controller to analyze the received laser pulses to determine the identity, location, and orientation of the targeted component and communicate such determination to the central controller module 50. Alternatively, the optic robot 20 may communicate pure signal data to the central controller module 50, which analyzes the signal data and determines the identity, location, and orientation of the targeted component based on the signal data.

During assembly of the components 61 and 62, the first assembly robot 14 grasps, moves, and holds the first component 61 according to programmed actions. Likewise, the second assembly robot 15 grasps, moves, and holds the second component 62 according to programmed actions. The assembly robots 14 and 15 are intended to position the components 61 and 62 in alignment for joining, whether mechanically or by adhesive, or both. At this point in the process, the optic robot 20 again transmits laser pulses at each component to determine the specific location and orientation of the component to make sure that the components are properly aligned for joining.

If the components 61 and 62 are not properly aligned, the central controller module 50 determines a location adjustment and/or an orientation adjustment needed to align the first component and the second component for joining, based on the location and orientation of each component. The location and/or orientation adjustment may require movement of one component or of both components. The central controller module 50 directs the first assembly robot 14 and/or the second assembly robot 15 to move the respective component 61 and/or 62 based on the location adjustment and/or the orientation adjustment to align the first component 61 and the second component 62 for joining. Thereafter, the central controller module 50 directs the fastening robot 18 or 19 to fasten the first component 61 to the second component 62 to form a joined component.

In an exemplary embodiment, the unmanned vehicle system 40 may be directed to bring into the assembly station 12 a third component (not shown) and additional components for assembly. Again, the optic robot 20 may direct laser pulses at the newly introduced components and identify the correct component for the next joining process, as well as its location and orientation. The second assembly robot 15 may release the joined component and grasp, move, and hold the third component in alignment with the joined component. Thus, the process of optically checking location and orientation for alignment before joining may be repeated.

In this manner, additional components may be further joined to build a subassembly and, eventually, completed assembly of components.

While FIG. 1 illustrates an assembly station 12 in which one pair of assembly robots and associated fastening robot(s) are directed by one optic robot, it is envisioned that multiple groupings of a pair of assembly robots and associated fastening robot(s) coordinated by one optic robot could be provided in a single assembly station. For example, an assembly station 12 may include four assembly robots, two or more fastening robots, and two optic robots for joining two different pairs of components.

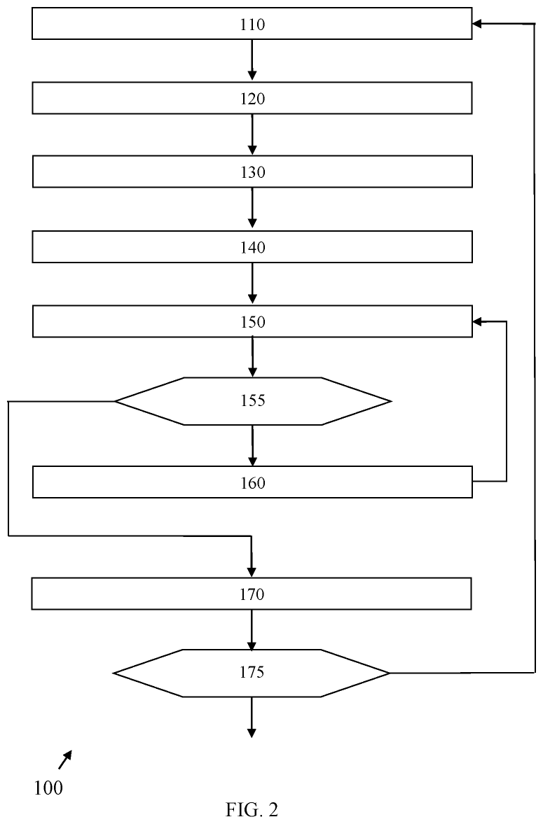

FIG. 2 provides a flow chart of a method 100 for assembling components. The method 100 includes introducing components to the assembly station at action block 110. As described above, an unmanned vehicle system can be used to deliver the components.

Further, method 100 includes checking the identity, location, and orientation of the components at action block 120. Such action includes directing a pattern or sequence of laser pulses from the optic robot to the components and receiving reflected pulses for analysis.

Method 100 includes grasping, moving, and holding each of the two components with a respective assembly robot at action block 130.

At action block 140, the method 100 again checks the identity, location, and orientation of the components.

Based on the reflected laser pulses, the location and orientation of each component is analyzed to determine whether a location and/or orientation adjustment is needed at action block 150. At inquiry 155, if a location and/or orientation adjustment is needed, the method 100 is directed to action block 160 wherein the components are moved based on the location and/or orientation adjustment.

The method 150 then proceed to repeat action block 150 to determine if further adjustment is needed. It is contemplated that the actions at action blocks 150 and 160 may be repeated iteratively until the components are within a pre-specified tolerance, with the position error being reduced with each iteration until limited by the accuracy of the laser radar or limited by the position control of the robot.

When the actions at action blocks 150 and 160 result in finding that no further adjustment is needed and that the components are aligned properly, inquiry 155 directs the method 100 to action block 170 where the components are joined as described above. At inquiry 175, method 100 determines whether the assembly at the assembly station is finished. If not, the method 100 restarts at action block 110. If so, the method may remove the joined components from the assembly station for further processing elsewhere.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. A method for assembling components, the method comprising:
grasping, with a first assembly robot, a first component from a respective initial position for assembly;
grasping, with a second assembly robot, a second component from a respective initial position for assembly;
determining, with an optic robot, an identity of the first component, a location of the first component, and an orientation of the first component;
evaluating, with the optic robot, whether features of the first component are accurately formed by determining whether component features are at expected locations;
determining, with the optic robot, an identity of the second component, a location of the second component, and an orientation of the second component;
evaluating, with the optic robot, whether features of the second component are accurately formed by determining whether component features are at expected locations;
based on the location and orientation of each component, determining a location adjustment and/or an orientation adjustment needed to align the first component and the second component for joining;
directing a respective assembly robot to move a respective component based on the location adjustment and/or the orientation adjustment to align the first component and the second component for joining; and
fastening, with a fastening robot, the first component to the second component to form a joined component;
identifying, with the optic robot, a third component from additional components for assembly for a next fastening process; and
evaluating, with the optic robot, whether features of the third component are accurately formed by determining whether component features are at expected locations;
wherein the optic robot is independent of the first assembly robot, the second assembly robot, and the fastening robot, wherein the optic robot includes a laser radar device configured to determine a location and an orientation of the first component the second component, and the third component and configured to determine a location and an orientation of the fastening robot.

2. The method of claim 1 wherein the optic robot is a three-dimensional vison-based position sensor selected from the group consisting of a laser radar device, a three-dimensional stereo vision device, a white-light projection sensor device, and a laser triangulation-based sensor device and mounted on a movable robot arm.

3. The method of claim 1 wherein determining, with the optic robot, the identity of the first component, the location of the first component, and the orientation of the first component comprises directing a pattern of laser pulses at the first component and analyzing reflected pulses.

4. The method of claim 1 wherein determining, with the optic robot, the identity of the first component, the location of the first component, and the orientation of the first component comprises identifying component features selected from component surface(s), component edge(s) and component opening(s).

5. The method of claim 1 wherein fastening, with the fastening robot, the first component to the second component comprises mechanically joining the first component to the second component.

6. The method of claim 1 wherein fastening, with the fastening robot, the first component to the second component comprises applying an adhesive to a surface of the first component and/or the second component, wherein the fastening robot holds an adhesive application device, and wherein the method includes controlling, with the optic robot, a location and orientation of the fastening robot to ensure that the adhesive is correctly applied to the surface of the first component and/or the second component.

7. The method of claim 1 further comprising moving, with an unanchored vehicle system, the first component and the second component to the respective initial positions.

8. The method of claim 1 further comprising moving, with an indexing system, a respective component to a respective initial position.

9. The method of claim 1 further comprising pre-qualifying each component with the optic robot by scanning each component and evaluating whether component features are accurately formed.

10. (Withdrawn and Currently Amended) The method of claim 1 further comprising:
releasing, from the second assembly robot, the joined component, wherein the first assembly robot continues grasping the joined component;
grasping, with the second assembly robot, the third component from an initial position for assembly;
determining, with the optic robot, an identity of the third component, a location of the third component, and an orientation of the third component;
based on the location and orientation of the third component, determining a location adjustment and/or an orientation adjustment needed to align the third component and the joined component for joining;
directing a respective assembly robot to move a respective component based on the location adjustment and/or the orientation adjustment to align the third component and the joined component for joining; and
fastening, with a fastening robot, the third component to the joined component to modify the joined component.

11. A method for manufacturing a vehicle, the method comprising:
providing a system for assembling components that includes:
a central controller module;
an optic robot in communication with the central controller module, wherein the optic robot includes a laser radar device;
a first assembly robot and a second assembly robot, each in communication with the central controller module; and
a fastening robot in communication with the central controller module;
evaluating, with the optic robot, whether features of a first component are accurately formed by determining whether component features are at expected locations;
grasping, with the first assembly robot, the first component;
evaluating, with the optic robot, whether features of a second component are accurately formed by determining whether component features are at expected locations;
grasping, with a second assembly robot, the second component;
transmitting, with the optic robot, a pattern of pulses at each component and receiving reflected pulses to determine a location and orientation of each component;
moving the first component and/or the second component to align the first component and the second component for joining;
fastening, with a fastening robot, the first component to the second component to form a joined component;
identifying, with the optic robot, a third component from additional components for assembly for a next fastening process; and
evaluating, with the optic robot, whether features of the third component are accurately formed by determining whether component features are at expected locations;
wherein the optic robot is independent of the first assembly robot, the second assembly robot, and the fastening robot, wherein the laser radar device is configured to determine the location and the orientation of the first component the second component, and the third component and is configured to determine a location and an orientation of the fastening robot.

12. The method of claim 11 wherein the optic robot is a laser radar device mounted on a movable robot arm, and wherein the pattern of pulses is a pattern of laser pulses.

13-17. (canceled)

18. A system for assembling components, the system comprising:
a central controller module;
a first assembly robot in communication with the central controller module, wherein the first assembly robot is configured to grasp and move a first component;
a second assembly robot in communication with the central controller module, wherein the second assembly robot is configured to grasp and move a second component;
a fastening robot in communication with the central controller module, wherein the fastening robot is configured to fasten together the first component and the second component;
additional components for assembly; and
an optic robot independent of the first assembly robot, the second assembly robot, and the fastening robot, wherein the optic robot is in communication with the central controller module, wherein the optic robot includes a laser radar device configured to determine a location and an orientation of the first component and the second component and configured to determine a location and an orientation of the fastening robot wherein the optic robot is configured to identify a third component from the additional components for assembly for a next fastening process; and wherein the optic robot is configured to evaluate whether features of the first component, the second component, and the third component are accurately formed by determining whether component features are at expected locations.

19. The system of claim 18 wherein:
the first assembly robot comprises a first robot arm anchored at a first fixed location;
the second assembly robot comprises a second robot arm anchored at a second fixed location;
the optic robot comprises a third robot arm anchored at a third fixed location; and
the fastening robot comprises a fourth robot arm anchored at a fourth location.

20. The system of claim 18 further comprising a mobile wheeled cart configured to move a selected component.

21. The system of claim 18 wherein the optic robot comprises a robot arm, and wherein the optic robot is dedicated to optical analysis such that the robot arm does not comprise any tool for grasping, holding, or moving the first robot assembly robot, the second assembly robot, the fastening robot, the first component, or the second component.

22. The system of claim 21 wherein the laser radar device is configured to analyze adhesive coverage and integrity during and/or after application of adhesive by the fastening robot.

23. The system of claim 22 wherein the optic robot is configured to control the location and the orientation of the fastening robot to ensure that the adhesive is correctly applied to the first component and/or the second component.

24. The system of claim 18 wherein the optic robot is configured to determine an identity of the first component an identity of the second component, and identity of the third component, and configured to pre-qualify the first component second component, and the third component by evaluating whether component features are accurately formed.

25. The system of claim 22 wherein the optic robot is configured to transmit a pattern of pulses at the first component, the second component, the third component, and the fastening robot to determine a respective location and respective orientation of the first component, the second component, the third component, and the fastening robot.
